(19) United States
(12) Patent Application Publication
(10) Pub. No.: US 2026/0205943 A1
(43) Pub. Date: Jul. 16, 2026

(54) JOINT ENERGIZING FOR AMBIENT POWER (AMP) DEVICES

(71) Applicant: Telefonaktiebolaget LM Ericsson (publ), Stockholm (SE)

(72) Inventors: Rocco DI TARANTO, Lund (SE); Leif WILHELMSSON, Lund (SE); Abhishek AMBEDE, Huddinge (SE)

(21) Appl. No.: 19/522,822

(22) PCT Filed: Oct. 9, 2023
(86) PCT No.: PCT/EP2023/077911

§ 371 Date: Mar. 25, 2026

(51) Int. Cl. H04W 52/02

(52) U.S. Cl. CPC H04W 52/0206

(57) ABSTRACT

A method, system and apparatus are disclosed. An orchestrating device is provided. Orchestrating device is in wireless communication with at least one energizing device and at least one ambient-power-only internet-of-things, AMP-only IoT, device. Orchestrating device is configured to indicate, to at least one energizing device, an energizing phase; and cause concurrent transmissions of non-data signals configured to power the at least one AMP-only IoT device, the concurrent transmissions including a respective energizing transmission by each of a set of energizing devices, the set of energizing devices including at least two of: the orchestrating device; a first energizing device of the at least one energizing devices; and a second energizing device of the at least one energizing devices.

### TECHNICAL FIELD

The present disclosure relates to wireless communications, and in particular, to joint energizing for ambient power (AMP) devices.

### BACKGROUND

Wi-Fi, also known as Wireless Local Area Network (WLAN), is a technology that currently mainly operates in the 2.4 GHz, or the 5 GHz band, or the 6 GHz band. There are specifications regulating an access points' or wireless terminals' physical (PHY) layer, medium access layer (MAC) layer and other aspects in order to secure compatibility and inter-operability between different WLAN entities, e.g., between an access point and mobile terminals, both of which may be referred to as stations (STAs) herein. Wi-Fi is generally operated in license-exempt bands, and as such, communication over Wi-Fi may be subject to interference sources from any number of known and unknown devices. Wi-Fi is commonly used as wireless extensions to fixed broadband access, e.g., in domestic environments and hotspots, like airports, train stations and restaurants.

In Internet-of-Things (IoT) networks, legacy IoT devices may be driven by batteries with a limited lifespan. This can negatively affect users'experiences and can limit the deployment of IoT devices in many use cases. Battery-free IoT communications have attracted interest in both Third Generation Partnership Project (3GPP) and Institute of Electrical Engineers (IEEE) standardization bodies (e.g., as specified in IEEE Technical Report (TR) 802.11-23/0436r0) because of their potential to improve network performance, be environmentally friendly, and be safer for children and the elderly. Moreover, by removing the battery, a device's size and cost may be reduced, thus enabling several new use cases.

A Wi-Fi IoT network may be competitive from the perspective of deployment cost, due to an already widespread deployment and use of license-exempt frequency spectrum. However, there are use cases and applications that may not yet be addressed using existing Wi-Fi technology, due to several reasons. First, a device powered by a conventional battery may be unable to operate under extreme environmental conditions (e.g., high pressure, extremely high/low temperature, or humid environments). Second, in certain situations, it may not be possible to replace a conventional battery, as needed by some conventional Wi-Fi battery powered devices. Finally, many IoT use-cases may require ultra-low complexity, very small device size/form factor IoT devices with a cost that is only a fraction of current Wi-Fi devices.

### AMP TIG/SG

During the May 2022 IEEE 802 interim session, an IEEE 802.11 Working Group (WG) motion was approved to form an Ambient Power (AMP) Topic Interest Group (TIG) (AMP TIG) to develop a technical report to describe use cases for IEEE 802.11 AMP-enabled IoT devices, and to investigate the technical feasibility of features to enable IEEE 802.11 WLAN support for ambient-power-enabled IoT devices.

At the March 2023 IEEE 802 plenary session, the AMP TIG approved the final version of the technical report (IEEE TR 802.11-23/0436r0) and requested a WG motion to form a Study Group (SG), which was approved.

Several use cases (e.g., logistics/warehouse and smart manufacturing) that may benefit from AMP IoT transmissions have been identified in IEEE TR 802.11-23/0436r0, as well as relevant requirements to fulfill the goals of the various services to provide. To support such use cases, multiple device types have also been considered by the TIG. Such device types were classified as 1) AMP-only IoT devices, and 2) AMP-assisted IoT devices.

An AMP-only IoT device features ultra-low complexity, ultra-low power consumption, very small form factor and operates without a conventional battery (battery-less device), as it has limited power storage (e.g., a capacitor). As such, an AMP-only IoT device may have lower capability than current Wi-Fi devices. For example, it may support less than 100 kbps data rate. Also, an AMP-only IoT device uses ambient power to energize itself and to communicate with other devices.

An AMP-assisted IoT device may have higher capabilities similar to current Wi-Fi devices. In some cases, a design target is achieving a maintenance-free IoT device that can operate without requiring a battery replacement. Such devices may need to be optimized for power consumption and sustainability.

### Ambient Backscattering

An ambient backscatter, also known as Radio Frequency (RF) backscatter, leverages conventional RF signals to transmit data without a battery or power grid connection. Each such device first uses an antenna to receive a conventional, typically low-power signal to charge its capacitor. Then, the device may use the collected energy for backscattering purposes. Backscattered signals may use higher power than the low-power signal used to charge the capacitor, if the backscattered transmission occurs over a small fraction of time compared to the time it took to charge the capacitor. For example, an RF backscatter may use the collected energy to modify and reflect an incoming signal with encoded data. Typically, a backscatter device applies frequency shifts to the illuminating carrier, and such shifts may be a few 10's of MHz. Higher frequency shifts require higher power.

### Energizing Phase and Illuminating Phase

During the energizing phase, AMP-only IoT devices, also referred to as “tags,” harvest RF energy radiated by conventional wireless communication devices. Energy is harvested to later power a tag's circuits, and there is no signal backscattered by the tag at this point.

During the illuminating phase, a tag and a conventional device have agreed on e.g., a tone (subcarrier), which is used for this phase. For example, the Access Point (AP) has previously sent a trigger telling which tone, or set of tones, is to be used for illumination. Then the AP sends an illuminating signal on this tone, and the tag backscatters the illuminating signal (may for example simply reflect a preamble, and/or encode information in the rest of the packet) with a certain frequency offset from the illuminating tone.

Illuminating and energizing phases can happen at the same time on different tones and/or channels (or parts of channels) in the same or different frequency bands. A tag can harvest energy while it backscatters an incoming signal. In some cases, energizing happens over large bandwidths (for example, over all the bandwidth reserved by the AP during a Transmission Opportunity (TXOP)), while only one or few tones are used for the illumination phase, as the backscattered signal may be narrowband or even a single tone.

### SUMMARY

Embodiments of the present disclosure provide configurations for joint energizing for AMP devices.

Many standardization bodies are considering battery-less devices, e.g., AMP-only IoT devices. Those devices may be unable to transmit or backscatter an incoming signal before their circuits are powered on (i.e., energized). When energizing is done via a RF signal in the same spectrum used for conventional wireless data transmissions, the energizing phase may introduce a large and intolerable overhead (as potential transmission time is used as energizing time), which in technologies operating in license-exempt spectrum, like Wi-Fi, may be a significant limitation. There is therefore a need to design protocols for energizing battery-less devices that mitigate or avoid such spectrum inefficiency.

Embodiments described herein relate to AMP-only IoT devices. Several different ambient power sources can be used to power AMP-only IoT devices. Energy can be harvested from different power sources, including RF transmissions, solar energy, thermal energy, etc. The present disclosure describes devices powered with RF transmissions, including transmissions according to, e.g., IEEE 802.11.

Embodiments described herein relate to backscatter AMP-only IoT devices that first use RF energy to power up their circuits and later may backscatter RF energy to encode information.

Embodiments described herein relate to a new transmission mode introduced in a network that involves AMP-only IoT devices, where all conventional devices (e.g., APs and non-AP stations (STAs) in a Wi-Fi network) transmit, concurrently, a pure-energy data-less signal (also referred to as “non-data signal”) for a certain time for energizing/illuminating purposes.

This pure-energy data-less signal may be transmitted omnidirectionally by all devices such that each device transmits a similar amount of energy in all directions (and, in some embodiments, shorter energizing sessions may suffice for tags that are in range of several conventional devices—such that one tag may be energized by many or potentially all devices), or using beamforming so that, with a certain level of coordination, different devices attempt to cover different (e.g., maximally disjoint) sectors or reach further distances (which may be at the cost of longer energizing sessions—e.g., since one tag may only be energized by a single or very few devices).

Advantages of a joint energizing phase include enhanced spectrum efficiency in presence of AMP-only IoT devices that are energized with RF energy in the same spectrum that is used for conventional wireless data transmissions. There are at least three reasons for this. First, with more devices sending energizing signals, the total energizing energy in an area can be increased. Second, it may not be obvious which device is the most suitable for transmitting an energizing signal, so by using more devices to transmit energizing signals, this problem can be addressed.

Third, if transmissions from several AMP-only IoT devices are to be multiplexed, if these devices are far apart, it may be unfeasible to use a single device for power all these devices. Because tags may need to be energized before they can operate or even be discovered, a new phase may be needed, which may result in unacceptable overhead (time for energizing). Embodiments described herein minimize such overhead.

By coordinating the energizing devices, which can then use joint beamforming strategies, devices may cover different areas and/or maximize coverage in certain directions (e.g., when overhead is not an issue, and it is more important to energize in all directions) and/or jointly energize in the same directions for quicker energizing phase (and reduced overhead).

Embodiments described herein are not limited to any particular standard or TXOP, e.g., those specified by IEEE 802.11, and can also be used in licensed spectrums.

According to one aspect of the present disclosure, an orchestrating device in wireless communication with at least one energizing device and at least one ambient-power-only internet-of-things, AMP-only IoT, device is provided. The orchestrating device includes processing circuitry configured to: indicate, to at least one energizing device, an energizing phase; and cause concurrent transmissions of non-data signals configured to power the at least one AMP-only IoT device, the concurrent transmissions including a respective energizing transmission by each of a set of energizing devices, the set of energizing devices including at least two of: the orchestrating device; a first energizing device of the at least one energizing devices; and a second energizing device of the at least one energizing devices. In embodiments, the orchestrating device is one of an access point (AP) or non-AP station (STA).

According to one or more embodiments of this aspect, the energizing phase occurs during a transmission opportunity, TXOP, of a license-exempt spectrum; and the indication of the energizing phase comprises indicating a frequency resource and an energizing phase time for the concurrent transmissions.

According to one or more embodiments of this aspect, the TXOP includes a plurality of other transmissions using a bandwidth; and the concurrent transmissions being transmitted using the frequency resource within the bandwidth during the energizing phase time.

According to one or more embodiments of this aspect, the energizing phase precedes a scheduled uplink, UL, transmission from the at least one AMP-only IoT device.

According to one or more embodiments of this aspect, the at least one AMP-only IoT device is a plurality of AMP-only IoT devices that include at least one known AMP-only IoT device and at least one unknown AMP-only IoT device.

According to one or more embodiments of this aspect, the respective non-data signals start with an Institute of Electrical Engineers, IEEE 802.11, preamble.

According to one or more embodiments of this aspect, the concurrent transmissions by each of the set of energizing devices are omnidirectional transmissions.

According to one or more embodiments of this aspect, the concurrent transmissions are beamformed transmissions.

According to one or more embodiments of this aspect, each of the beamformed transmissions covers a respective area, each respective area being substantially non-overlapping of other respective areas.

According to one or more embodiments of this aspect, the processing circuitry is further configured to select at least one energizing device from the set of energizing devices, a configuration of at least one beamformed transmission caused by the at least one selected device being selected based on at least one of an amount of power required by an area covered by the at least one beamformed transmission and a distance between the area and the at least one selected device.

According to another aspect of the present disclosure, a method implemented in an orchestrating device in wireless communication with at least one energizing device and at least one ambient-power-only internet-of-things, AMP-only IoT, device is provided. The method includes: indicating, to at least one energizing device, an energizing phase; and causing concurrent transmissions of non-data signals configured to power the at least one AMP-only IoT device, the concurrent transmissions including a respective energizing transmission by each of a set of energizing devices, the set of energizing devices including at least two of: the orchestrating device; a first energizing device of the at least one energizing devices; and a second energizing device of the at least one energizing devices.

According to one or more embodiments of this aspect, the energizing phase occurs during a transmission opportunity, TXOP, of a license-exempt spectrum; and the indication of the energizing phase comprises indicating a frequency resource and an energizing phase time for the concurrent transmissions.

According to one or more embodiments of this aspect, the TXOP includes a plurality of other transmissions using a bandwidth; and the concurrent transmissions being transmitted using the frequency resource within the bandwidth during the energizing phase time.

According to one or more embodiments of this aspect, the energizing phase precedes a scheduled uplink, UL, transmission from the at least one ambient-power-only internet-of-things, AMP-only IoT device.

According to one or more embodiments of this aspect, the at least one AMP-only IoT device is a plurality of AMP-only IoT devices that include at least one known AMP-only IoT device and at least one unknown AMP-only IoT device.

According to one or more embodiments of this aspect, the respective non-data signals start with an Institute of Electrical Engineers, IEEE 802.11, preamble.

According to one or more embodiments of this aspect, the concurrent transmissions by each of the set of energizing devices are omnidirectional transmissions.

According to one or more embodiments of this aspect, the concurrent transmissions are beamformed transmissions.

According to one or more embodiments of this aspect, each of the beamformed transmissions covers a respective area, each respective area being substantially non-overlapping of other respective areas.

According to one or more embodiments of this aspect, the method further includes selecting at least one energizing device from the set of energizing devices, a configuration of at least one beamformed transmission caused by the at least one selected device being selected based on at least one of an amount of power required by an area covered by the at least one beamformed transmission and a distance between the area and the at least one selected device.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

A more complete understanding of the present embodiments, and the attendant advantages and features thereof, will be more readily understood by reference to the following detailed description when considered in conjunction with the accompanying drawings wherein:

FIG. 1 is a schematic diagram of an example network architecture illustrating a communication system according to the principles in the present disclosure;

FIG. 2 is a block diagram of an AP communicating with a non-AP STA over an at least partially wireless connection according to some embodiments of the present disclosure;

FIG. 3 is a schematic diagram of an example network architecture illustrating a communication system connected via an intermediate network to a host computer according to the principles in the present disclosure;

FIG. 4 is a block diagram of a host computer communicating via an access point with a non-AP STA over an at least partially wireless connection according to some embodiments of the present disclosure;

FIG. 5 is a flowchart illustrating example methods implemented in a communication system including a host computer, an access point and a non-AP STA for executing a client application at a non-AP STA according to some embodiments of the present disclosure;

FIG. 6 is a flowchart illustrating example methods implemented in a communication system including a host computer, an access point and a non-AP STA for receiving user data at a non-AP STA according to some embodiments of the present disclosure;

FIG. 7 is a flowchart illustrating example methods implemented in a communication system including a host computer, an access point and a non-AP STA for receiving user data from the non-AP STA at a host computer according to some embodiments of the present disclosure;

FIG. 8 is a flowchart illustrating example methods implemented in a communication system including a host computer, an access point and a non-AP STA for receiving user data at a host computer according to some embodiments of the present disclosure;

FIG. 9 is a flowchart of an example process in an AP according to some embodiments of the present disclosure;

FIG. 10 is a schematic diagram of an example network deployment according to some embodiments of the present disclosure;

FIG. 11 is another schematic diagram of an example network deployment according to some embodiments of the present disclosure; and

FIG. 12 is a block diagram of an example transmission opportunity according to some embodiments of the present disclosure.

### DETAILED DESCRIPTION

Before describing the example embodiments in detail, it is noted that the embodiments reside primarily in combinations of apparatus components and processing steps related to joint energizing of AMP devices. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” “top” and “bottom,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “coupled,” “connected,” and the like, may be used herein to indicate a connection, although not necessarily directly, and may include wired and/or wireless connections.

In some embodiments, the term “access point” or “AP” is used interchangeably and may comprise, or be, a network node. The AP may include any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), relay node, integrated access and backhaul (IAB), donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3^{rd} party node, a node external to the current network), nodes in distributed antenna system (DAS), a spectrum access system (SAS) node, an element management system (EMS), etc. The AP may also comprise test equipment. The AP may comprise a radio router, a radio transceiver, Wi-Fi access point, wireless local area network (WLAN) access point, a network controller, etc.

In some embodiments, the non-limiting term “device” is used to describe a wireless device (WD) and/or user equipment (UE) that may be used to implement some embodiments of the present disclosure. In some embodiments, the device may be and/or comprise an access point (AP) station (STA). In some embodiments, the device may be and/or comprise a non-access point station (non-AP STA). In some embodiments, the device may be any type of device capable of communicating with a network node, such as an AP, over radio signals. The device may be any radio communication device, target device, a portable device, device-to-device (D2D) device, machine type device or device capable of machine to machine communication (M2M), low-cost and/or low-complexity device, a sensor equipped with a device, a computer, Tablet, mobile terminals, smart phone, laptop embedded equipped (LEE), laptop mounted equipment (LME), USB dongles, Customer Premises Equipment (CPE), an Internet of Things (loT) device, or a Narrowband loT (NB-IoT) device, Reduced Capability (RedCap) device, etc.

A device may be considered a network node and may include physical components, such as processors, allocated processing elements, or other computing hardware, computer memory, communication interfaces, and other supporting computing hardware. The network node may use dedicated physical components, or the node may be allocated use of the physical components of another device, such as a computing device or resources of a datacenter, in which case the network node is said to be virtualized. A network node may be associated with multiple physical components that may be located either in one location, or may be distributed across multiple locations.

Even though the descriptions herein may be explained in the context of one of a Downlink (DL) and an Uplink (UL) communication, it should be understood that the basic principles disclosed may also be applicable to the other of the one of the DL and the UL communication. In some embodiments in this disclosure, the principles may be considered applicable to a transmitter and a receiver. For DL communication, the AP station may be the transmitter and the receiver is the non-AP station. For the UL communication, the transmitter may be the non-AP station and the receiver is the AP station.

Note also that some embodiments of the present disclosure may be supported by an Institute of Electrical Engineers (IEEE) 802.11 standard. IEEE 802.11 denotes a set of Wireless Local Area Network (WLAN) air interface standards developed by the IEEE 802.11 committee for short-range communications (e.g., tens of meters to a few hundred meters). Some embodiments may also be supported by standard documents disclosed in Third Generation Partnership Project (3GPP) technical specifications. That is, some embodiments of the description can be supported by the above documents. In addition, all the terms disclosed in the present document may be described by the above standard documents.

Note that although terminology from one particular wireless system, such as, for example, IEEE 802.11, 3^{rd} Generation Partnership Project (3GPP), Long Term Evolution (LTE), 5^{th} Generation (5G) and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by one or more of a STA, AP, non-AP STA, wireless device, network node, etc., may be distributed over a plurality of STAs, APs, non-AP STAs, wireless devices, network nodes, etc. In other words, it is contemplated that the functions of the devices described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

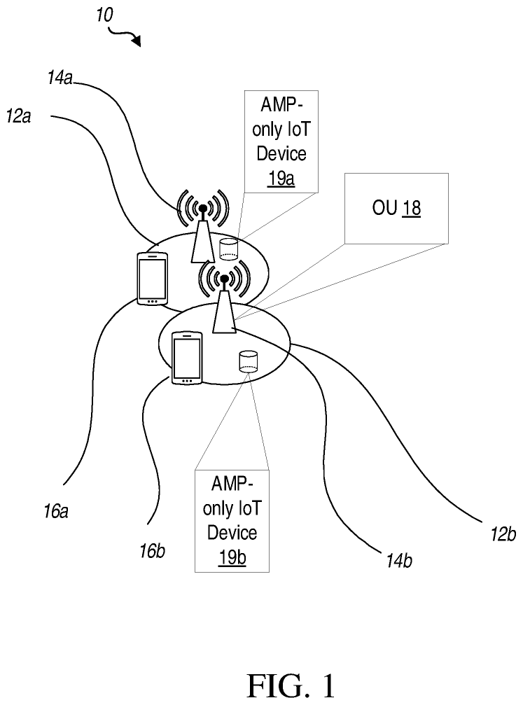

Some embodiments provide configurations for joint energizing for AMP devices. Referring again to the drawing figures, in which like elements are referred to by like reference numerals, there is shown in FIG. 1 a schematic diagram of the communication system 10, according to one embodiment, constructed in accordance with the principles of the present disclosure. The communication system 10 in FIG. 1 is a non-limiting example and other embodiments of the present disclosure may be implemented by one or more other systems and/or networks. Referring to FIG. 1, system 10 may comprise a wireless local area network (WLAN). The devices in the system 10 may communicate over one or more spectrums, such as, for example, a license-exempt or unlicensed spectrum, which may include frequency bands typically used by Wi-Fi technology. One or more of the devices may be further configured to communicate over other frequency bands, such as shared licensed frequency bands, etc. The system 10 may include one or more coverage areas 12a, 12b, etc. (collectively referred to herein as “coverage area 12”), which may be defined by corresponding access points (APs) 14a, 14b, etc. (collectively referred to herein as “AP 14”). The AP 14 may or may not be connectable to another network, such as a core network over a wired or wireless connection. The system 10 includes a plurality of non-AP devices, such as, for example, non-AP STAs 16a, 16b, 16c (collectively referred to as non-AP STAs 16). Each of the non-AP STAs 16 may be located in one or more coverage areas 12 and may be configured to wirelessly connect to one or more AP 14. Note that although two APs 14a and 14b and two non-AP STAs 16a and 16b are shown for convenience, the communication system may include many more non-AP STAs 16 and APs 14. Each AP 14 may connect to serve/configure/schedule/etc. one or more non-AP STAs 16. The system 10 includes a plurality of AMP-only IoT devices 19a, 19b, etc. (collectively referred to as AMP-only IoT devices 19). Note that although two AMP-only IoT devices 19a and 19b are shown for convenience, the communication system may include many more AMP-only IoT devices 19.

It should be understood that the system 10 may include additional nodes/devices not shown in FIG. 1. In addition, the system 10 may include many more connections/interfaces than those shown in FIG. 1. Thus, the elements shown in FIG. 1 are presented for ease of understanding.

Also, it is contemplated that a non-AP STA 16 can be in communication and/or configured to separately communicate with more than one AP 14 and/or more than one type of AP 14. Furthermore, an AP 14 may be in communication and/or configured to separately communicate with other APs 14, which may be via wired and/or wireless communication channels.

An AP 14 is configured to include an orchestration unit 18, which is configured to perform one or more AP 14 functions described herein, such as joint energizing for AMP devices.

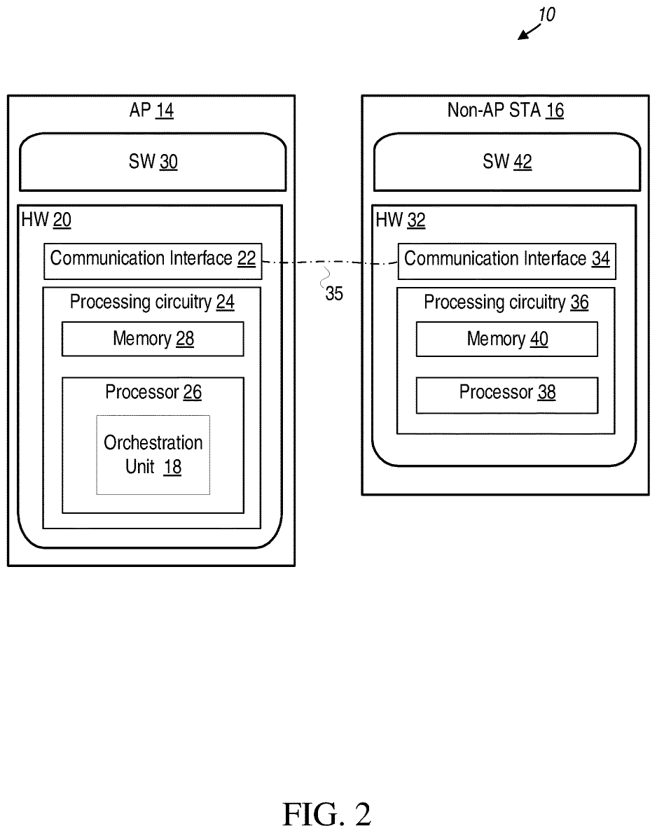

Example implementations, in accordance with an embodiment, of the AP 14 and non-AP STA 16 discussed in the preceding paragraphs will now be described with reference to FIG. 2.

The AP 14 includes hardware 20 including a communication interface 22, processing circuitry 24, a processor 26, and memory 28. The communication interface 22 may be configured to communicate with any of the nodes/devices in the system 10 according to some embodiments of the present disclosure, such as with one or more other APs 14 and/or one or more non-AP STAs 16. In some embodiments, the communication interface 22 may be formed as or may include, for example, one or more radio frequency (RF) transmitters, one or more RF receivers, and/or one or more RF transceivers, and/or may be considered a radio interface. In some embodiments, the communication interface 22 may also include a wired interface.

The processing circuitry 24 may include one or more processors 26 and memory, e.g., memory 28. In addition to a processor 26 and memory 28, the processing circuitry 24 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 26 may be configured to access (e.g., write to and/or read from) the memory 28, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

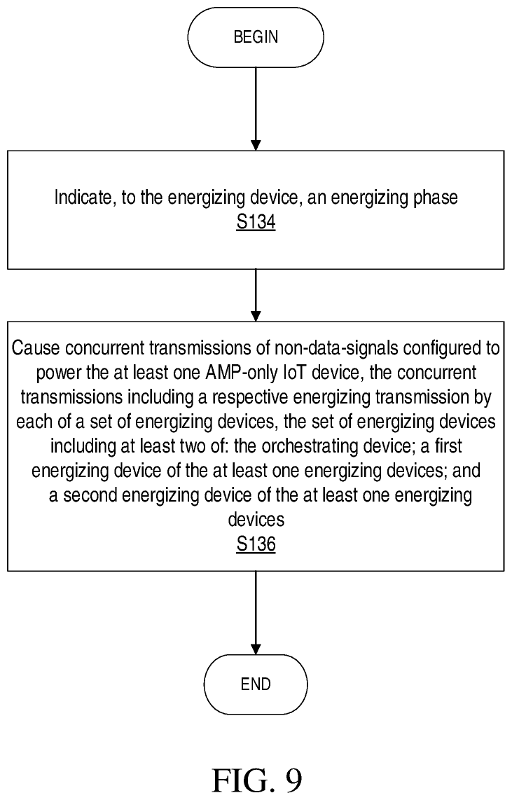

The AP 14 may further include software 30 stored internally in, for example, memory 28, or stored in external memory (e.g., database) accessible by the AP 14 via an external connection. The software 30 may be executable by the processing circuitry 24. The processing circuitry 24 may be configured to control any of the methods and/or processes described herein and/or to cause such methods, and/or processes to be performed, e.g., AP 14. The memory 28 is configured to store data, programmatic software code and/or other information described herein. In some embodiments, the software 30 may include instructions stored in memory 28 that, when executed by the processor 26 and/or orchestration unit 18 causes the processing circuitry 24 and/or configures the AP 14 to perform the processes described herein with respect to the AP 14 (e.g., processes described with reference to FIG. 9 and/or any of the other figures herein).

Referring still to FIG. 2, the non-AP STA 16 includes hardware 32, which may include a communication interface 34, processing circuitry 36, a processor 38, and memory 40. The communication interface 34 may be configured to communicate with one or more AP 14, such as via wireless connection 35, and/or with other elements in the system 10, according to some embodiments of the present disclosure. In some embodiments, the communication interface 34 may be formed as or may include, for example, one or more radio frequency (RF) transmitters, one or more RF receivers, and/or one or more RF transceivers, and/or may be considered a radio interface. In some embodiments, the communication interface 34 may also include a wired interface.

The processing circuitry 36 may include one or more processors 38 and memory, such as, the memory 40. Furthermore, in addition to a traditional processor and memory, the processing circuitry 36 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 38 may be configured to access (e.g., write to and/or read from) the memory 40, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the non-AP STA 16 may further include software 42 stored internally in, for example, memory 40, or stored in external memory (e.g., database) accessible by the non-AP STA 16 via an external connection. The software 42 may be executable by the processing circuitry 36. The processing circuitry 36 may be configured to control any of the methods and/or processes described herein and/or to cause such methods, and/or processes to be performed, e.g., by the non-AP STA 16. The memory 40 is configured to store data, programmatic software code and/or other information described herein. In some embodiments, the software may include instructions stored in memory 40 that, when executed by the processor 38, causes the processing circuitry 36 and/or configures the non-AP STA 16 to perform the processes described herein with respect to the non-AP STA 16 (e.g., processes described with reference to FIG. 9 and/or any of the other figures herein).

In FIG. 2, the connection between the devices AP 14 and the non-AP STAs 16 is shown without explicit reference to any intermediary devices or connections. However, it should be understood that intermediary devices and/or connections may exist between these devices, although not explicitly shown.

Although FIG. 2 shows orchestration unit 18, as being within a processor, it is contemplated that this element may be implemented such that a portion of the element is stored in a corresponding memory within the processing circuitry. In other words, the element may be implemented in hardware or in a combination of hardware and software within the processing circuitry.

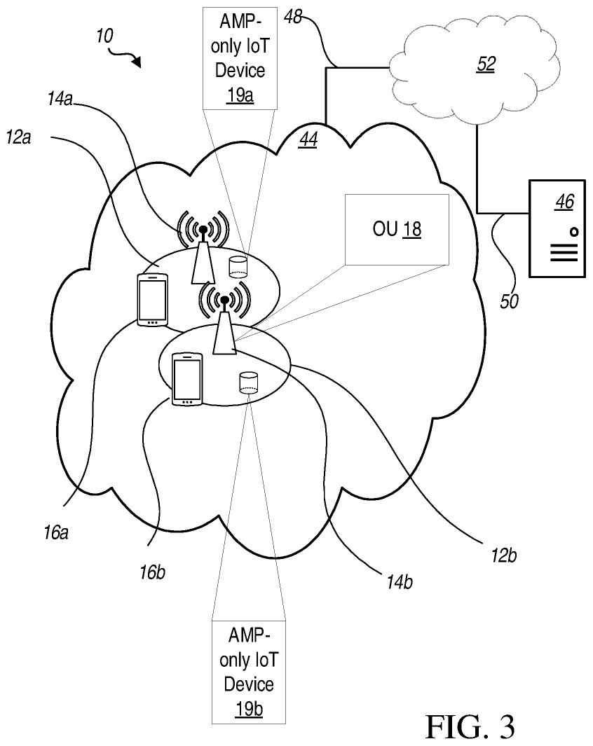

FIG. 3 is a schematic diagram of a communication system 10, according to another embodiment of the present disclosure. In the example of FIG. 3, the access point 14 and non-AP STAs 16 may be similar to those of the example of FIG. 1, described herein. Additionally, in the example of FIG. 3, one or more APs 14 and/or non-AP STAs 16 may form and/or be part of a service set network 44 (e.g., a basic service set, or any other network, set, and/or grouping of APs 14 and non-AP STAs 16). The communication system 10 and/or service set network 44 may itself be connected to a host computer 46, which may be embodied in the hardware and/or software of a standalone server, a cloud-implemented server, a distributed server or as processing resources in a server farm. The host computer 46 may be under the ownership or control of a service provider, or may be operated by the service provider or on behalf of the service provider. The connections 48, 50 between the communication system 10 and/or the service set network 44 and the host computer 46 may extend directly from the service set network 44 to the host computer 46 or may extend via an optional intermediate network 52. The intermediate network 52 may be one of, or a combination of more than one of, a public, private or hosted network. The intermediate network 52, if any, may be a backbone network or the Internet. In some embodiments, the intermediate network 52 may comprise two or more sub-networks (not shown).

The communication system of FIG. 3 as a whole enables connectivity between one of the connected non-AP STAs 16 and the host computer 46. The connectivity may be described as an over-the-top (OTT) connection. The host computer 46 and the connected non AP-STAs 16 are configured to communicate data and/or signaling via the OTT connection, using the service set network 44, any intermediate network 52 and possible further infrastructure (not shown) as intermediaries. The OTT connection may be transparent in the sense that at least some of the participating communication devices through which the OTT connection passes are unaware of routing of uplink and downlink communications. For example, an AP 14 may not or need not be informed about the past routing of an incoming downlink communication with data originating from a host computer 46 to be forwarded (e.g., handed over) to a connected non-AP STA 16. Similarly, the AP 14 need not be aware of the future routing of an outgoing uplink communication originating from the non-AP STA 16 towards the host computer 46.

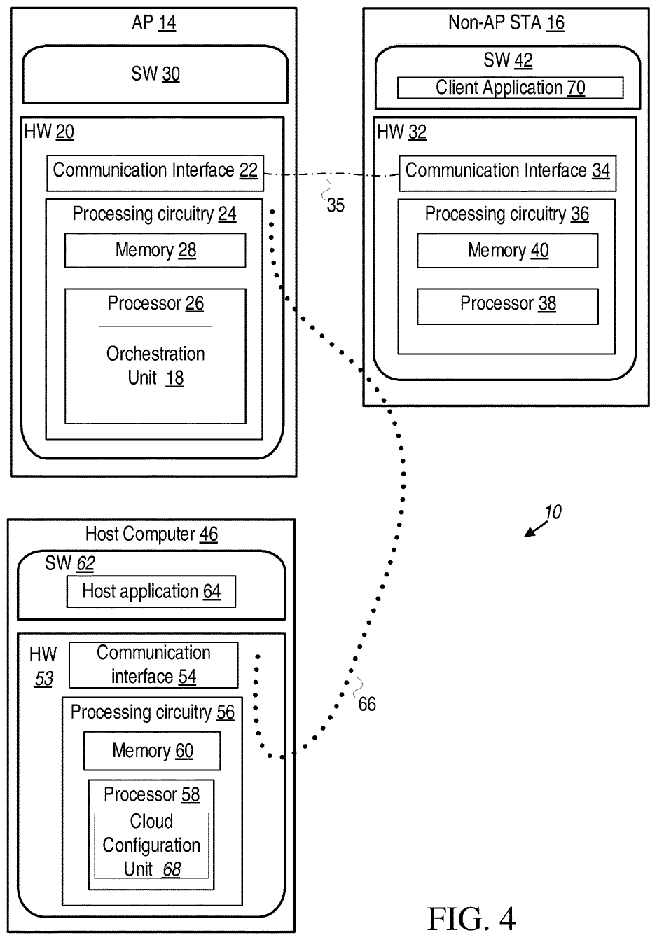

Example implementations, in accordance with an embodiment, of the non-AP STA 16, AP 14, and host computer 46 discussed in the preceding paragraphs will now be described with reference to FIG. 4. In the example of FIG. 4, the AP 14 and the non-AP STA 16 may have similar features and components as the AP 14 and non-AP STA 16 depicted in FIG. 2. Additionally, the host computer 46 comprises hardware (HW) 53 including a communication interface 54 configured to set up and maintain a wired or wireless connection with an interface of a different communication device of the communication system 10. The host computer 46 further comprises processing circuitry 56, which may have storage and/or processing capabilities. The processing circuitry 56 may include a processor 58 and memory 60. In particular, in addition to or instead of a processor, such as a central processing unit, and memory, the processing circuitry 56 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 58 may be configured to access (e.g., write to and/or read from) memory 60, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 56 may be configured to control any of the methods and/or processes described herein and/or to cause such methods, and/or processes to be performed, e.g., by host computer 46. Processor 58 corresponds to one or more processors 58 for performing host computer 46 functions described herein. The host computer 46 includes memory 60 that is configured to store data, programmatic software code and/or other information described herein. In some embodiments, the software 62 and/or the host application 64 may include instructions that, when executed by the processor 58 and/or processing circuitry 56, causes the processor 58 and/or processing circuitry 56 to perform the processes described herein with respect to host computer 46. The instructions may be software associated with the host computer 46.

The software 62 of host computer 46 may be executable by the processing circuitry 56. The software 62 includes a host application 64. The host application 64 may be operable to provide a service to a remote user, such as a non-AP STA 16 connecting via an OTT connection 66 terminating at the non-AP STA 16 and the host computer 46. In providing the service to the remote user, the host application 64 may provide user data which is transmitted using the OTT connection 66. The “user data” may be data and information described herein as implementing the described functionality. In one embodiment, the host computer 46 may be configured for providing control and functionality to a service provider and may be operated by the service provider or on behalf of the service provider. The processing circuitry 56 of the host computer 46 may enable the host computer 46 to observe, monitor, control, transmit to and/or receive from the AP 14 and/or the non-AP STA 16. The processing circuitry 56 of the host computer 46 may include a Cloud Configuration unit 68 configured to enable the service provider to observe/monitor/control/transmit to/receive from/configure/etc. the AP 14 and/or the non-AP STA 16.

The communication interface 22 of AP 14 may be configured to facilitate a connection 66 to the host computer 46. The connection 66 may be direct or it may pass through a service set network 44 of the communication system 10 and/or through one or more intermediate networks 52 outside the communication system 10. The communication interface 34 of non-AP STA 16 may be configured to facilitate a connection 66 to the host computer 46. The connection 66 may be direct or it may pass through a service set network 44 of the communication system 10 and/or through one or more intermediate networks 52 outside the communication system 10.

The software 42 of non-AP STA 16 may include a client application 70. The client application 70 may be operable to provide a service to a human or non-human user via the non-AP STA 16, with the support of the host computer 46. In the host computer 46, an executing host application 64 may communicate with the executing client application 70 via the OTT connection 66 terminating at the non-AP STA 16 and the host computer 46. In providing the service to the user, the client application 70 may receive request data from the host application 64 and provide user data in response to the request data. The OTT connection 66 may transfer both the request data and the user data. The client application 70 may interact with the user to generate the user data that it provides.

In some embodiments, the inner workings of the AP 14, non-AP STA 16, and host computer 46 may be as shown in FIG. 4 and independently, the surrounding network topology may be that of FIG. 3.

In FIG. 4, the OTT connection 66 has been drawn abstractly to illustrate the communication between the host computer 46 and the non-AP STA 16 via the AP 14, without explicit reference to any intermediary devices and the precise routing of messages via these devices. Network infrastructure may determine the routing, which may be configured to hide from the non-AP STA 16 or from the service provider operating the host computer 46, or both. While the OTT connection 66 is active, the network infrastructure may further take decisions by which it dynamically changes the routing (e.g., on the basis of load balancing consideration or reconfiguration of the network).

The wireless connection 35 between the non-AP STA 16 and the AP 14 is in accordance with the teachings of the embodiments described throughout this disclosure. One or more of the various embodiments improve the performance of OTT services provided to the non-AP STA 16 using the OTT connection 66, in which the wireless connection 35 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 66 between the host computer 46 and non-AP STA 16, in response to variations in the measurement results. The measurement procedure and/or the network functionality for reconfiguring the OTT connection 66 may be implemented in the software 62 of the host computer 46 or in the software 42 of the non-AP STA 16, or both. In embodiments, sensors (not shown) may be deployed in or in association with communication devices through which the OTT connection 66 passes; the sensors may participate in the measurement procedure by supplying values of the monitored quantities exemplified above, or supplying values of other physical quantities from which software 62, 42 may compute or estimate the monitored quantities. The reconfiguring of the OTT connection 66 may include message format, retransmission settings, preferred routing etc.; the reconfiguring need not affect the AP 14, and it may be unknown or imperceptible to the AP 14. Some such procedures and functionalities may be known and practiced in the art. In certain embodiments, measurements may involve proprietary wireless device signaling facilitating the host computer's 46 measurements of throughput, propagation times, latency and the like. In some embodiments, the measurements may be implemented in that the software 62, 42 causes messages to be transmitted, in particular empty or ‘dummy’ messages, using the OTT connection 66 while it monitors propagation times, errors, etc.

Thus, in some embodiments, the host computer 46 includes processing circuitry 56 configured to provide user data and a communication interface 54 that is configured to forward the user data to a wireless network and/or cellular network for transmission to the non-AP STA 16. In some embodiments, the wireless network and/or cellular network also includes the AP 14 with a communication interface 22. In some embodiments, the AP 14 is configured to, and/or the AP 14 processing circuitry 24 is configured to perform the functions and/or methods described herein for preparing/initiating/maintaining/supporting/ending a transmission to the non-AP STA 16, and/or preparing/terminating/maintaining/supporting/ending in receipt of a transmission from the non-AP STA 16.

In some embodiments, the host computer 46 includes processing circuitry 56 and a communication interface 54 that is configured to receive user data originating from a transmission from a non-AP STA 16 to an AP 14. In some embodiments, the non-AP STA 16 is configured to, and/or comprises a communication interface 34 and/or processing circuitry 36 configured to perform the functions and/or methods described herein for preparing/initiating/maintaining/supporting/ending a transmission to the AP 14, and/or preparing/terminating/maintaining/supporting/ending in receipt of a transmission from the AP 14.

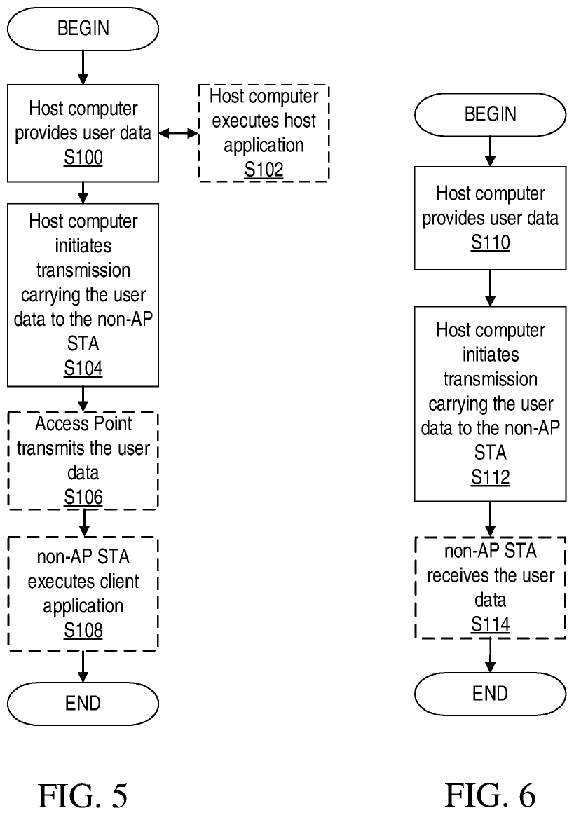

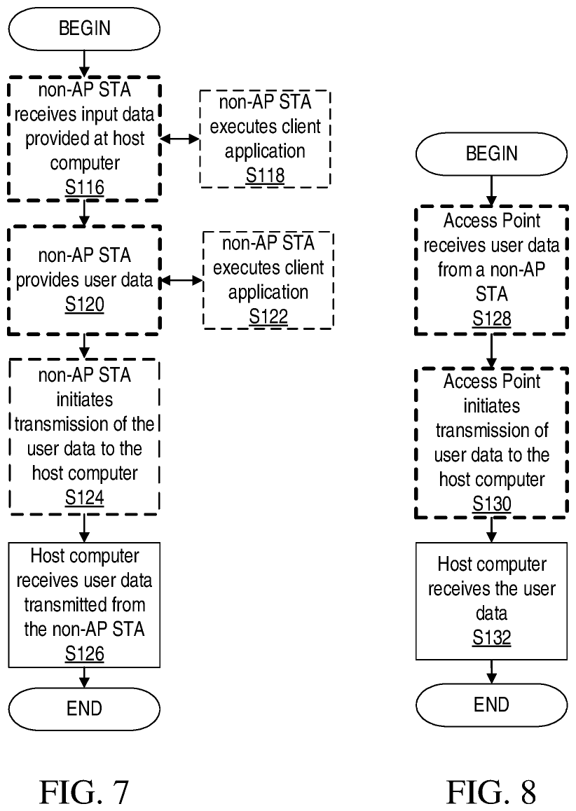

FIG. 5 is a flowchart illustrating an exemplary method implemented in a communication system, such as, for example, the communication system of FIGS. 7 and 8, in accordance with one embodiment. The communication system may include a host computer 46, an AP 14 and a non-AP STA 16, which may be those described with reference to FIG. 4. In a first step of the method, the host computer 46 provides user data (Block S100). In an optional substep of the first step, the host computer 46 provides the user data by executing a host application, such as, for example, the host application 64 (Block S102). In a second step, the host computer 46 initiates a transmission carrying the user data to the non-AP STA 16 (Block S104). In an optional third step, the AP 14 transmits to the non-AP STA 16 the user data which was carried in the transmission that the host computer 46 initiated, in accordance with the teachings of the embodiments described throughout this disclosure (Block S106). In an optional fourth step, the non-AP STA 16 executes a client application, such as, for example, the client application 70, associated with the host application 64 executed by the host computer 46 (Block S108).

FIG. 6 is a flowchart illustrating an exemplary method implemented in a communication system, such as, for example, the communication system of FIG. 3, in accordance with one embodiment. The communication system may include a host computer 46, an AP 14 and a non-AP STA 16, which may be those described with reference to FIGS. 7 and 8. In a first step of the method, the host computer 46 provides user data (Block S110). In an optional substep (not shown) the host computer 46 provides the user data by executing a host application, such as, for example, the host application 64. In a second step, the host computer 46 initiates a transmission carrying the user data to the non-AP STA 16 (Block S112). The transmission may pass via the AP 14, in accordance with the teachings of the embodiments described throughout this disclosure. In an optional third step, the non-AP STA 16 receives the user data carried in the transmission (Block S114).

FIG. 7 is a flowchart illustrating an exemplary method implemented in a communication system, such as, for example, the communication system of FIG. 3, in accordance with one embodiment. The communication system may include a host computer 46, an AP 14 and a non-AP STA 16, which may be those described with reference to FIGS. 7 and 8. In an optional first step of the method, the non-AP STA 16 receives input data provided by the host computer 46 (Block S116). In an optional substep of the first step, the non-AP STA 16 executes the client application 70, which provides the user data in reaction to the received input data provided by the host computer 46 (Block S118). Additionally or alternatively, in an optional second step, the non-AP STA 16 provides user data (Block S120). In an optional substep of the second step, the non-AP STA 16 provides the user data by executing a client application, such as, for example, client application 70 (Block S122). In providing the user data, the executed client application 70 may further consider user input received from the user. Regardless of the specific manner in which the user data was provided, the non-AP STA 16 may initiate, in an optional third substep, transmission of the user data to the host computer 46 (Block S124). In a fourth step of the method, the host computer 46 receives the user data transmitted from the non-AP STA 16, in accordance with the teachings of the embodiments described throughout this disclosure (Block S126).

FIG. 8 is a flowchart illustrating an exemplary method implemented in a communication system, such as, for example, the communication system of FIG. 3, in accordance with one embodiment. The communication system may include a host computer 46, an AP 14 and a non-AP STA 16, which may be those described with reference to FIGS. 7 and 8. In an optional first step of the method, in accordance with the teachings of the embodiments described throughout this disclosure, the AP 14 receives user data from the non-AP STA 16 (Block S128). In an optional second step, the AP 14 initiates transmission of the received user data to the host computer 46 (Block S130). In a third step, the host computer 46 receives the user data carried in the transmission initiated by the AP 14 (Block S132).

FIG. 9 is a flowchart of an example process in a first AP 14 (e.g., a sharing AP). Though the example process is depicted as performed by a first AP 14, it should be appreciated that in at least one embodiment, it may be performed in an orchestration unit 18 of a non-AP STA 16. One or more Blocks and/or functions and/or methods performed by the first AP 14 (e.g., sharing AP 14) may be performed by one or more elements of the first AP 14 such as by orchestration unit 18 in processing circuitry 24, memory 28, processor 26, communication interface 22, etc. according to the example process/method. The first AP 14 is configured to indicate, to the energizing device (which may be, e.g., an AP 14 or non-AP STA 16), an energizing phase (Block S134). The first AP 14 is configured to cause concurrent transmissions of non-data signals configured to power the at least one AMP-only IoT device, the concurrent transmissions including a respective energizing transmission by each of a set of energizing devices, the set of energizing devices including at least two of: the orchestrating device; a first energizing device of the at least one energizing devices; and a second energizing device of the at least one energizing devices (Block S136).

In some embodiments, the energizing phase occurs during a transmission opportunity, TXOP, of a license-exempt spectrum; and the indication of the energizing phase includes indicating a frequency resource and an energizing phase time for the concurrent transmissions.

In some embodiments, the TXOP includes a plurality of other transmissions using a bandwidth; and the concurrent transmissions being transmitted using the bandwidth during the energizing phase time.

In some embodiments, the energizing phase precedes a scheduled uplink, UL, transmission from the at least one AMP-only IoT device 19.

In some embodiments, the at least one AMP-only IoT device 19 is a plurality of AMP-only IoT devices 19 that comprise at least one known AMP-only IoT device 19 and at least one unknown AMP-only IoT device 19.

In some embodiments, the respective non-data signals are configured based on a peak-to-average-power ratio, PAPR, starting with an Institute of Electrical Engineers, IEEE 802.11, preamble.

In some embodiments, the concurrent transmissions by each of the set of energizing devices are omnidirectional transmissions.

In some embodiments, the concurrent transmissions are beamformed transmissions.

In some embodiments, each of the beamformed transmissions covers a respective area, each respective area being substantially non-overlapping of other respective areas.

In some embodiments, the processing circuitry 24 is further configured to select at least one energizing device from the set of energizing devices, a configuration of at least one beamformed transmission caused by the at least one selected device being selected based on at least one of an amount of power required by an area covered by the at least one beamformed transmission and a distance between the area and the at least one selected device.

In some embodiments, the processing circuitry 24 is further configured to select the set of energizing devices such that the concurrent transmissions have a total radiated power less than a predetermined maximum.

In some embodiments, the processing circuitry 24 is further configured to select the set of energizing devices based on a link budget limitation.

In some embodiments, the transmissions of non-data signals use first frequency resources; the non-data signals are configured to be used by the at least one AMP-only IoT device 19 for backscattering using second frequency resources different from the first frequency resources and having a frequency offset.

In some embodiments, at least one of the energizing devices is simultaneous transmit and receive, STR, capable and is configured to transmit the non-data signal using a set of frequency resources and to receive the backscattered signal concurrently on another set of frequency resources.

In some embodiments, the processing circuitry 24 is further configured to: cause only selected ones of the first set of energizing devices to transmit the non-data signals on a first frequency; and cause the at least one AMP-only IoT device 19 to backscatter, on a second frequency with the frequency offset to the first frequency, to the energizing devices of the first set of energizing devices that are not selected to transmit the non-data signals.

In some embodiments, the set of energizing devices includes at least two non-access point stations, non-AP STAs, and the processing circuitry 24 is further configured to: cause only the at least two non-AP STAs to transmit the non-data signals; and cause the at least one AMP-only IoT device 19 to backscatter to at least one access point, AP, which is not of the set of energizing devices, wherein the backscattering principle is similar to the described above ..

In some embodiments, the set of energizing devices includes at least two access points, APs, and the processing circuitry 24 is further configured to: cause only the at least two AP to transmit the non-data signals; and cause the at least one AMP-only IoT device 19 to backscatter to at least one non-access point station, non-AP STA, which is not of the set of energizing devices, wherein the backscattering principle is similar to the described above.

Having described the general process flow of arrangements of the disclosure and having provided examples of hardware and software arrangements for implementing the processes and functions of the disclosure, the sections below provide details and examples of arrangements for supporting configurations for joint energizing for AMP devices. One or more AP 14 functions described below may be performed by one or more of processing circuitry 24, processor 26, orchestration unit 18, etc.

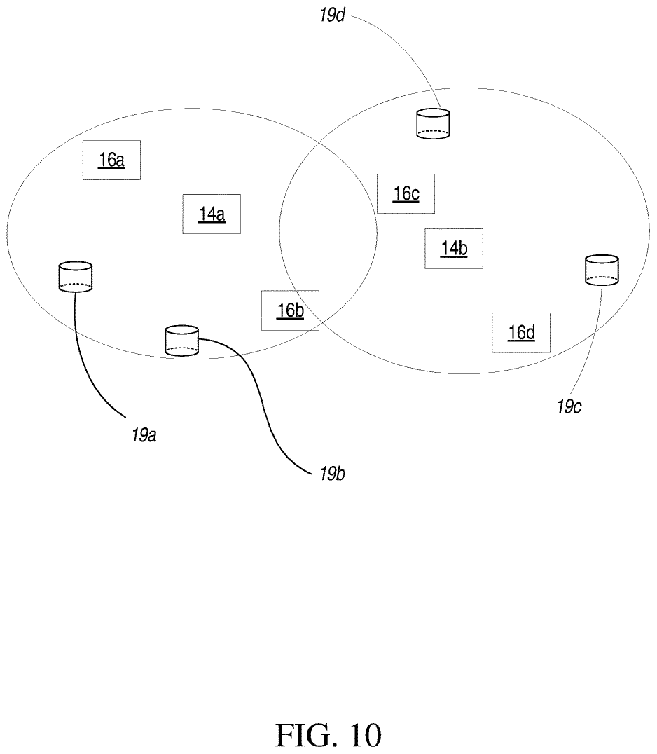

FIG. 10 depicts an example scenario, with several APs 14, connected non-AP STAs 16, and AMP-only IoT devices 19, (also referred to herein as “tags”), deployed in the coverage areas of the conventional Wi-Fi devices (e.g., the APs 14 and non-AP STAs 16). The conventional devices may be aware, or may not be aware, of the presence of the tags. If the conventional devices are unaware of the presence of some or all tags, the energizing procedures described herein may be needed even for tag discovery.

The tags are battery-less and, before starting their operations (and even being discovered) they may need to be energized. Some embodiments described herein relate to RF tag energizing using the same frequency spectrum as may be used for conventional data transmissions.

In some embodiments, a conventional wireless communication device (such as an AP 14 or non-AP STA 16) is an orchestrating device that orchestrates the operations described herein. That is, the underlying hardware of conventional wireless communication device may comprise conventional hardware, but the functions of conventional wireless communication device described herein are specifically configured functions that are not conventional functions. First, the orchestrating device transmits a control frame to one or more other devices indicating an upcoming energizing/illuminating period. After this control frame transmission, multiple devices, possibly including the orchestrating device, transmit concurrently a non-data signal (e.g., pure-energy data-less signal) in certain frequency resources (e.g., a channel or a sub-part of a channel) for a certain time.

In at least one embodiment, at a certain point in time, one conventional device, e.g., AP1 14a, coordinates the operation so that all conventional devices (may refer, as used herein, to non-AMP devices such as battery-based devices or devices connected to a power supply (e.g., 220/110V)) (both APs 14 and STAs 16) transmit at the same time on certain frequency resources so that energy is spread in all directions, and the in-range tags can harvest RF energy to power up their circuits in a short time.

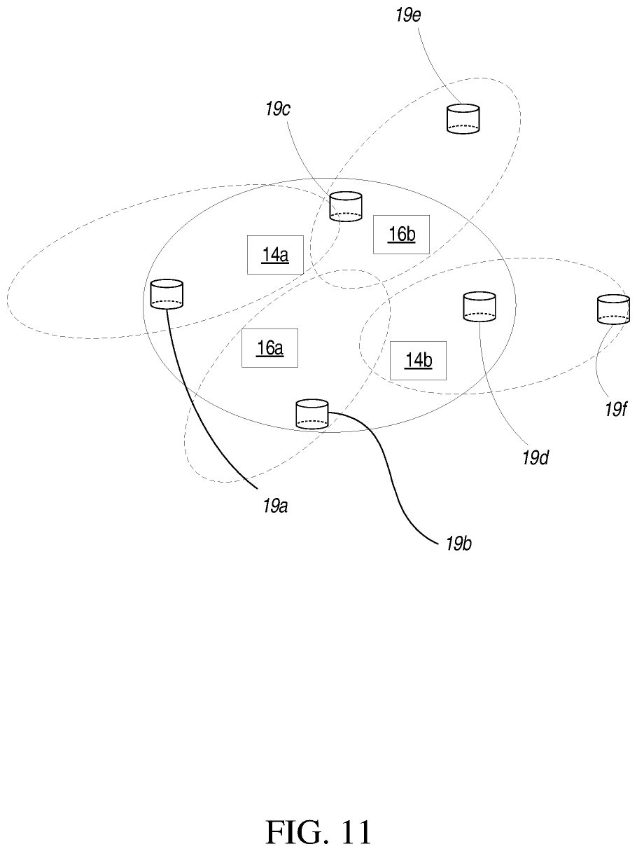

In at least one embodiment, such as that depicted in FIG. 11, the conventional devices, before entering the energizing phase, coordinate their precoder strategies. In FIG. 11, for example, different devices energize in different sectors. By doing so, each device radiates energy in certain directions only, and therefore tags (e.g., AMP-only IoT devices 19e and 19f) that would not be energized with omnidirectional transmissions can be reached.

In at least one embodiment, the operations described relating to FIG. 10 and FIG. 11 are performed in a licensed spectrum. In at least one embodiment, such operations are performed in a license-exempt spectrum, and the orchestrating device first reserves a time-frequency resource to be used for energizing (and possibly transmission) purposes, and then performs the orchestration as described above.

In at least one embodiment operations are in license-exempt spectrum and conventional devices (APs 14 and non-AP STAs 16) operate according to an IEEE 802.11 standard.

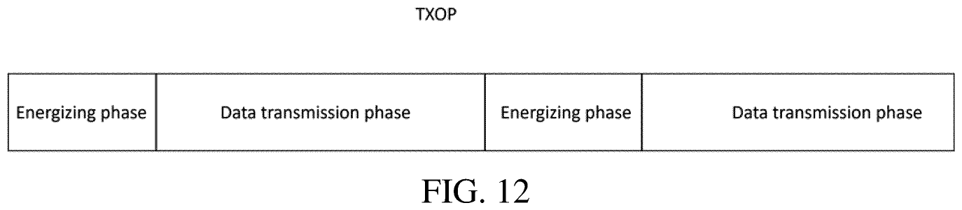

FIG. 12 shows an example transmission opportunity in a network, such as is specified, e.g., in IEEE 802.11, where the orchestration device has reserved a TXOP. The orchestration device may first coordinate one or more conventional devices for an energizing phase, and then coordinate operations for data transmission phase.

In at least one embodiment, the energizing phase is performed only on the corresponding resource units (RUs) (which may be, e.g., groups of sub-carriers as defined e.g., in IEEE 802.11ax or IEEE P 802.11be amendments), used for data transmission to/from the tag. In at least one embodiment, the energizing phase for all tags takes place on all reserved bandwidth. As an example, 20 MHz is occupied in a TXOP. Then, 9 AMP devices may be scheduled in the uplink (UL) using the smallest Rus, and the full 20 MHz may be used to charge the 9 AMP devices.

In at least one embodiment, a bandwidth as large as possible is reserved in the TXOP for the energizing phase for faster charging. This may be beneficial, for example, in power spectral density (PSD) limited scenarios.

With reference to FIG. 12, in at least one embodiment, the energizing phase takes place before a scheduled data transmission from the AMP tags. For a tag to operate, the energizing phase may be a necessity, and there may not be a transmission if energizing is not performed or is performed too early before transmissions (e.g., the capacitor may discharge too quickly once energized).

In at least one embodiment, the non-data signal (e.g., pure-energy data-less signal) starts with a preamble, such as specified in, e.g., IEEE 802.11. This preamble may be backscattered (without being modified) by the tag if needed for communication purposes.

In at least one embodiment, the non-data signal is chosen so that it has specific properties, e.g., in terms of peak to average power ratio (PAPR), or other properties specifically designed for effectively energizing AMP backscattering tags, e.g. for transmitting backscattered signal with a certain frequency offset with respect to the receiving carrier. A signal with high PAPR may reach tags at longer distances. Alternatively, or additionally, a signal with high PAPR would allow certain time instances wherein AMP backscattering tags may be energized by a much higher power than the average power of the energizing signal-this may allow for more efficient or faster energizing.

In at least one embodiment, the orchestrating device selects the set of devices that participate in the energizing/illuminating phase so that the total power radiated is less than the maximum power allowed by regulatory bodies.

In at least one embodiment, the orchestrating device selects the set of devices that participate in the energizing/illuminating phase so that link budget limitations are taken into consideration toward certain known AMP backscattering tags. For instance, if some potential energizing/illuminating device is known to be far from all AMP backscattering tags that will be scheduled, such a device may be requested not to participate in the energizing/illuminating phase since it will not be of any use.

### Concurrent Energizing and Backscattering

Once a backscattering tag has energized circuits, it can backscatter an incoming signal. Backscattering may consist in that the incoming signal is partly reflected (this may be the case of, e.g., an IEEE 802.11 preamble) and partly modified and encoded with data (this may be the tag information to be shared with the other nodes). The backscattered signal is typically transmitted with a certain frequency offset with respect to the receiving carrier.

In at least one embodiment, the non-data signal is sent by the conventional devices (e.g., AP 14 and/or non-AP STA 16) to energize AMP scattering tags and to be used to be backscattered by the AMP tags to (some) conventional devices on certain frequency resources(e.g., a channel or a sub-part of a channel) with a certain offset (pre-determined and reserved by the orchestrating device as discussed elsewhere herein) at the same time, and where the certain frequency resources are not the same as the frequency resources used for transmitting the non-data signal.

In at least one embodiment, one or more conventional devices are simultaneous transmit and receive (STR) capable so that they can transmit the non-data signal on one set of frequency resources and receive the backscattered signal concurrently on another set of frequency resources (where STR capability is, e.g., sub-band full duplex (SBFD) capability).

In at least one embodiment, the non-data signal is chosen, e.g., by the orchestrating device, so that it has specific properties, e.g., in terms of PAPR, or other properties specifically designed for energizing AMP backscattering devices and to be backscattered by AMP tags on a different set of frequency resources.

In at least one embodiment, a (pre-agreed) subset of devices (e.g., AP 14 and/or non-AP STA 16) sends the non-data signal on one frequency (AMP tags backscatter to non-transmitting devices on another frequency with the frequency offset to the frequency of non-data signal). The pre-agreed subset may consist of AP STA only, non-AP STA only, or a mix thereof.

Example embodiments include:

Example 1. A wireless communication device (e.g., AP 14 or non-AP STA 16) orchestrating an operation, where
a. The orchestrating device transmits a control frame to one or more other devices indicating an upcoming energizing/illuminating phase,
b. Multiple devices, possibly including the orchestrating device, transmit concurrently a pure-energy data-less signal (i.e., a type of non-data signal) in certain frequency resources (e.g., a channel or a sub-part of a channel) for a certain time.

Example 2. As in Example 1, where the operations are in license-exempt spectrum and the orchestrating device reserves a transmit opportunity in time and frequency.

Example 3. As in any of Examples 1-2, where operations are in an IEEE 802.11 network operating in license-exempt spectrum and the orchestrating device reserves a TXOP.

Example 4. As in any of Examples 1-3, where the energizing/illuminating phase is scheduled, within a TXOP, just before a scheduled UL transmission from battery-less devices.

Example 5. As in any of Examples 1-4, where the pure-energy data-less signal is sent over the same bandwidth as is used for all the scheduled transmissions during the reserved TXOP.

Example 6. As in any of Examples 1-5, where the pure energy data-less signal starts with legacy IEEE 802.11 preamble.

Example 7. As in any of Examples 1-6, where the pure-energy data-less signal is sent to energize, i.e., power on circuits in a known or unknown number of AMP backscattering tags.

Example 8. As in Example 7, where the pure-energy data-less signal is chosen so that it has specific properties, e.g., in terms of PAPR, or other properties specifically designed for energizing AMP backscattering tags.

Example 9. As in any of Examples 1-8, where all devices transmit omnidirectionally.

Example 10. As in any of Examples 1-8, where devices coordinate and apply beamforming strategies for the operation being orchestrated.

Example 11. As in Example 10, where beamforming strategies at devices are chosen so that each device covers a different (maximally disjoint) area.

Example 12. As in Example 10, where beamforming strategies at certain devices are chosen so that a certain area is covered with more power, or certain directions are covered at longer distances.

Example 13. As in any of Examples 1-12, where the orchestrating device selects the set of devices that participate in the energizing/illuminating phase so that the total power radiated is less than the maximum power allowed by regulatory bodies.

Example 14. As in any of Examples 1-13, where the orchestrating device selects the set of devices that participate in the energizing/illuminating phase so that link budget limitations are taken into consideration toward certain known AMP backscattering tags.

Example 15. As in any of Examples 1-14, where the pure-energy data-less signal is sent to energize AMP scattering tags and to be used to be backscattered by the AMP tags on certain frequency resources (e.g., a channel or a sub-part of a channel) with a certain offset at the same time (pre-determined and reserved by the orchestrating device), and where the certain frequency resources are not the same as the frequency resources used for transmitting the pure-energy data-less signal.

Example 16. As in Example 15, wherein one or more devices are STR (simultaneous transmit and receive) capable so that they can transmit the pure-energy data-less signal on one set of frequency resources and receive the backscattered signal concurrently on another set of frequency resources (where STR capability is e.g., SBFD capability).

Example 17. As in any of Examples 15-16, where the pure-energy data-less signal is chosen so that it has specific properties, e.g., in terms of PAPR, or other properties specifically designed for energizing AMP backscattering devices and to be backscattered by AMP tags on a different set of frequency resources.

Example 18. As in any of Examples 15-17, where a (pre-agreed or pre-selected) subset of devices sends the pure-energy data-less signal (AMP tags backscatter to non-transmitting devices on a disjoint frequency).

Example 19. As in any of Examples 15-18, where only non-AP STAs send the pure-energy data-less signal (in this case, AMP tags backscatter to the AP on non-identical frequency resources).

Example 20. As in any of Examples 15-18, where only the AP STA(s) send the pure-energy data-less signal (in this case, AMP tags backscatter to the non-AP STAS on non-identical frequency resources).

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Python, Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider). Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. An orchestrating device in wireless communication with at least one energizing device and at least one ambient-power-only internet-of-things, AMP-only IoT, device, the orchestrating device comprising processing circuitry configured to:
indicate, to at least one energizing device, an energizing phase; and
cause concurrent transmissions of non-data signals configured to power the at least one AMP-only IoT device, the concurrent transmissions including a respective energizing transmission by each of a set of energizing devices, the set of energizing devices including at least two of:
the orchestrating device;
a first energizing device of the at least one energizing device; and
a second energizing device of the at least one energizing device.

2. The orchestrating device of claim 1, wherein:
the energizing phase occurs during a transmission opportunity, TXOP, of a license-exempt spectrum; and
to indicate the energizing phase comprises indicating a frequency resource and an energizing phase time for the concurrent transmissions.

3. The orchestrating device of claim 2, wherein:
the TXOP includes a plurality of other transmissions using a bandwidth; and
the concurrent transmissions being transmitted using the frequency resource within the bandwidth during the energizing phase time.

4. The orchestrating device of claim 1, wherein the energizing phase precedes a scheduled uplink, UL, transmission from the at least one AMP-only IoT device.

5. The orchestrating device of claim 1, wherein the at least one AMP-only IoT device is a plurality of AMP-only IoT devices that comprise at least one known AMP-only IoT device and at least one unknown AMP-only IoT device.

6. The orchestrating device of claim 5, wherein the respective non-data signals start with an Institute of Electrical Engineers, IEEE 802.11, preamble.

7. The orchestrating device of claim 1, wherein the concurrent transmissions by each of the set of energizing devices are omnidirectional transmissions.

8. The orchestrating device of claim 1, wherein the concurrent transmissions are beamformed transmissions.

9. The orchestrating device of claim 8, wherein each of the beamformed transmissions covers a respective area, each respective area being substantially non-overlapping of other respective areas.

10. The orchestrating device of claim 8, wherein the processing circuitry is further configured to select at least one energizing device from the set of energizing devices, a configuration of at least one beamformed transmission caused by the at least one selected device being selected based on at least one of an amount of power required by an area covered by the at least one beamformed transmission and a distance between the area and the at least one selected device.

11. A method implemented in an orchestrating device in wireless communication with at least one energizing device and at least one ambient-power-only internet-of-things, AMP-only IoT, device the method comprising:
indicating, to at least one energizing device, an energizing phase; and
causing concurrent transmissions of non-data signals configured to power the at least one AMP-only IoT device, the concurrent transmissions including a respective energizing transmission by each of a set of energizing devices, the set of energizing devices including at least two of:
the orchestrating device;
a first energizing device of the at least one energizing devices; and
a second energizing device of the at least one energizing devices.

12. The method of claim 11, wherein:
the energizing phase occurs during a transmission opportunity, TXOP, of a license-exempt spectrum; and
to indicate the energizing phase comprises indicating a frequency resource and an energizing phase time for the concurrent transmissions.

13. The method of claim 12, wherein:
the TXOP includes a plurality of other transmissions using a bandwidth; and
the concurrent transmissions being transmitted using the frequency resource within the bandwidth during the energizing phase time.

14. The method of claim 11, wherein the energizing phase precedes a scheduled uplink, UL, transmission from the at least one AMP-only IoT device.

15. The method of claim 11, wherein the at least one AMP-only IoT device is a plurality of AMP-only IoT devices that comprise at least one known AMP-only IoT device and at least one unknown AMP-only IoT device.

16. The method of claim 15, wherein the respective non-data signals start with an Institute of Electrical Engineers, IEEE 802.11, preamble.

17. The method of claim 11, wherein the concurrent transmissions by each of the set of energizing devices are omnidirectional transmissions.

18. The method of claim 11, wherein the concurrent transmissions are beamformed transmissions.

19. The method of claim 18, wherein each of the beamformed transmissions covers a respective area, each respective area being substantially non-overlapping of other respective areas.

20. The method of claim 19, further comprising selecting at least one energizing device from the set of energizing devices, a configuration of at least one beamformed transmission caused by the at least one selected device being selected based on at least one of an amount of power required by an area covered by the at least one beamformed transmission and a distance between the area and the at least one selected device.
